(19) United States
(12) Patent Application Publication
(10) Pub. No.: US 2011/0150035 A1
(43) Pub. Date: Jun. 23, 2011

(54) NON-INTRUSIVE METHOD FOR SENSING GAS TEMPERATURE AND SPECIES CONCENTRATION IN GASEOUS ENVIRONMENTS

(76) Inventors: Ronald K. Hanson, Cupertino, CA (US); Jay B. Jeffries, Palo Alto, CA (US)

(21) Appl. No.: 12/970,002

(22) Filed: Dec. 16, 2010

Related U.S. Application Data
(60) Provisional application No. 61/287,279, filed on Dec. 17, 2009.

(51) Int. Cl. G01K 11/12

(52) U.S. Cl. 374/161; 374/E11.018

(57) ABSTRACT

The invention relates generally to a non-intrusive method for sensing gas temperature and species concentration in gaseous environments. The method includes the steps of providing a tunable diode laser (TDL) sensor having a plurality of robust telecommunications diode lasers and a detector. The method further includes the steps of positioning the TDL sensor in alignment with an optical port of a vessel; using the lasers to transmit light through the optical port; using the detector to receive the transmitted light and transmit a signal to a data collection device; determining a ratio of absorbance for different absorption transitions; and determining a gas temperature from the ratio of absorbance.

### BACKGROUND OF THE INVENTION

The present invention relates generally to a non-intrusive method for sensing gas temperature and species concentration in gaseous environments.

Ever-increasing fuel costs and government regulations on combustion systems continue to drive the development of more efficient combustion devices. As combustion technologies mature, gains in combustion efficiency become more difficult to achieve and accurate diagnostics, often located near the reaction zone of the device, are necessary to evaluate small differences between various device designs. In addition, active control with sensor feedback becomes important to maintain optimum efficiency through transients in system operating points and fuel streams.

Since carbon dioxide (CO₂) is a major product of combustion and occurs atmospherically only at very low levels, measurement of CO₂ in a reacting system provides the most direct measure of combustion efficiency. Other combustion technologies such as gasification, in which carbonaceous materials are converted into carbon monoxide and hydrogen, also gain valuable information on the composition of the output gas stream through the monitoring of CO₂. Since many of these combustion devices (internal combustion engines, gas turbine engines, and coal gasifiers) operate at high pressures, the ability to design practical, field-deployable CO₂ sensors capable of accurate measurements at high pressure is increasingly important.

Recent field-deployable sensors for high-pressure reacting environments have focused primarily on H₂O absorption in the near infrared (NIR) spectral region. They employ telecommunications grade diode lasers operating near 1.4 μm using either direct absorption spectroscopy, wavelength modulation spectroscopy, or NIR hyperspectral sources using direct absorption spectroscopy. The near-infrared region is especially attractive for measurements of coal gasification, as key reactant and product species absorb at these wavelengths (for example H₂O vapor, CO₂, CO and CH₄), and robust telecommunications diode lasers are available to develop practical, fiber-coupled sensors. FIG. 1 shows the infrared spectra of H₂O and CO₂ from 1 to 3 μm at 1000K.

Unfortunately, extending sensor capability to high-pressure environments is made difficult by the broadening and overlap of discrete spectral features at high gas density. All high-pressure absorption sensors must rely on comparisons between measurement and simulation to infer gas properties (pressure, temperature, concentration), and therefore accurate spectral simulations are required. Fortunately, several spectral databases have been compiled which include CO₂, and some comparisons between measurement and simulation have been carried out.

For example, Burch et al. performed measurements on the 1.4, 2.7, and 4.3 μm regions of CO₂ and revealed that even at pressures of a few atmospheres, CO₂ absorption spectra exhibit non-ideal behavior. Of particular importance is the effect of finite-duration collisions, which are not accounted for by the impact approximation inherent to the simple Lorentzian line shape profile commonly used to describe collisional broadening. Several researchers focused on the 4.3 μm region of CO₂, and their measurements at temperatures up to 800 K and pressures up to 60 atm were used to deduce empirical _{X}-functions to correct for the effects of finite-duration collisions in the far wings of the Lorentzian profile.

One significant area where optical sensors would be beneficial is in coal gasifiers. Coal-based power plants are the leading source of electricity in the world, and while renewable sources are expected to have a growing role, coal resources will continue to be a valuable commodity. The United States Department of Energy predicts that coal's share of the electric power production in the United States will grow from fifty percent in 2004 to fifty-seven percent in 2030, which will require 174 GW of new coal-fueled generation capacity.

Variations in the composition of the coal feedstock can lead to significant off-design performance of the coal gasifier; thus it is important to monitor the chemical composition of the synthesis gas stream. Such data allows control of oxygen and fuel feed rates for optimum gasifier performance.

The ability to provide near-instantaneous, constant monitoring of gas composition and temperature within or near the gasifier has the potential to allow better control of gasifier performance and to provide an opportunity to dynamically tailor inlet feedstocks to optimize operation of the gasifier. In the case of integrated gasification combined-cycle (IGCC) system applications, such measurements on the gasifier output could enable new gas turbine control strategies.

The coal gasification process operates at elevated temperatures and pressures, creating an extremely harsh environment that challenges time-resolved monitoring and control. Intrusive probe sampling in these highly reactive, multiphase environments is plagued by short operational lifetimes. The gasifier environment also offers significant challenges for quantitative laser absorption measurements. First, the high operating pressures broaden the individual transitions, and accounting for the broadening and blending of the absorption spectrum is a scientific challenge. Second, the attenuation of the transmitted laser beam by scattering from particulate in the flow and fouling of the windows provides significant engineering challenges.

Accordingly, there is a need for a non-intrusive method for sensing gas temperature and species concentration in gaseous environments.

### BRIEF SUMMARY OF THE INVENTION

These and other shortcomings of the prior art are addressed by the present invention, which provides tunable diode laser (TDL) absorption sensing for measuring temperature and species concentration in gaseous environments.

According to one aspect of the present invention, a method for sensing gas temperature and species concentration in gaseous environments includes the steps of providing a tunable diode laser (TDL) sensor; using the TDL sensor to determine a ratio of absorbance for different absorption transitions; and determining a gas temperature from the ratio of absorbance.

According to another aspect of the present invention, a method for sensing gas temperature and species concentration in gaseous environments includes the steps of providing a tunable diode laser (TDL) sensor having a plurality of robust telecommunications diode lasers and a detector. The method further including the steps of positioning the TDL sensor in alignment with an optical port of a vessel; using the lasers to transmit light through the optical port; using the detector to receive the transmitted light and transmit a signal to a data collection device; determining a ratio of absorbance for different absorption transitions; and determining a gas temperature from the ratio of absorbance.

According to another aspect of the present invention, a method for sensing gas temperature and species concentration in high pressure gaseous environments includes the steps of providing a plurality of tunable diode laser (TDL) sensors. Each of the TDL sensors include a plurality of robust telecommunications diode lasers and a detector. The method further including the steps of positioning the plurality of TDL sensors in optical alignment with respective optical ports of a pressure vessel such that the diode lasers and detector of each TDL sensor are in optical alignment with each other; using the TDL sensors to transmit and receive light through each of the respective optical ports; transmitting a signal representative of a ratio of absorbance for absorption transitions; determining the ratio of absorbance for absorption transitions; and determining a gas temperature from the ratio of absorbance.

### BRIEF DESCRIPTION OF THE DRAWINGS

The subject matter that is regarded as the invention may be best understood by reference to the following description taken in conjunction with the accompanying drawing figures in which:

FIG. 1 shows the infrared spectra of H₂O and CO₂ from 1 to 3 μm at 1000K;

FIG. 2 shows a wavelength-multiplexed diode laser sensor according to an embodiment of the invention;

FIG. 3 shows absorption of isolated water vapor transmission;

FIG. 4 shows _{X}-functions versus frequency de-tuning from line center for CO₂-CO₂ collisions and CO₂-N₂ collisions at 296 K;

FIG. 5 shows an experimental setup with a high pressure static cell;

FIG. 6 direct absorption spectrum, 10.8% CO₂ in air, L=100 cm, T=296K;

FIG. 7 shows a simulated direct absorption spectrum of the 20012←00001 band of CO₂ near 2.0 μm;

FIG. 8 shows 1f-normalized WMS-2f spectrum, P=1 atm;

FIG. 9 shows 1f-normalized WMS-2f spectrum, P=5 atm;

FIG. 10 shows 1f-normalized WMS-2f spectrum, P=10 atm;

FIG. 11 shows a comparison of simulations using HITRAN 04 and Toth et al. spectral parameters;

FIG. 12 shows a fluidized bed gasification system;

FIG. 13 shows potential locations for gas sensors for a combined cycle power plant;

FIG. 14 is a reactor showing locations where TDL absorption measurements may be made;

FIG. 15 shows a wavelength-multiplexed diode laser sensor according to an embodiment of the invention;

FIG. 16 shows injection current scanned TDL measurements of direct absorption and wavelength modulation spectroscopy with 2f detection;

FIG. 17 shows TDL measurements of temperature at a 100 Hz bandwidth compared to wall-mounted thermocouples;

FIG. 18 shows laser transmission across the lower port attenuated by a splash of bed material;

FIG. 19 shows statistical uncertainty of the temperature determined by the TDL sensor as a function of transmitted light intensity;

FIG. 20 shows statistical uncertainty of the temperature determined by the TDL sensor as a function of transmitted light intensity;

FIG. 21 shows a reactor core and cooling water quench of an entrained-flow gasifier;

FIG. 22 shows syn-gas products before particulate filter and after filter clean-up;

FIG. 23 shows an optical access;

FIG. 24 is a schematic of an air curtain;

FIG. 25 shows laser sensor determined gas temperature at reactor exit;

FIG. 26 shows laser sensor determined water concentration at reactor exit;

FIG. 27 shows a single-sweep direct absorption measurement for a methane pre-heat flame; and

FIG. 28 shows a single-sweep direct absorption measurement for coal gasification.

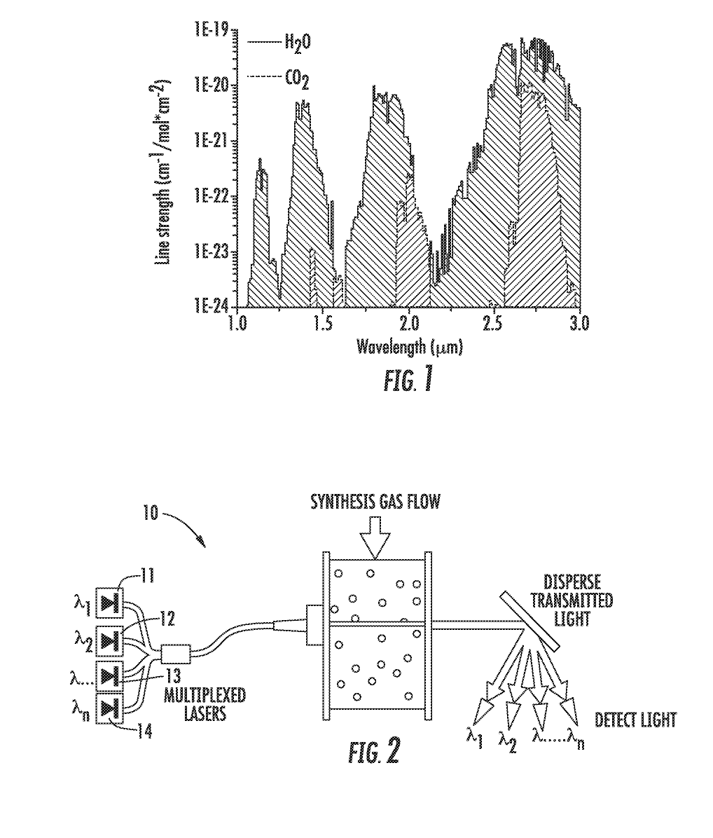

### DETAILED DESCRIPTION OF THE INVENTION

Optical absorption sensing using tunable diode lasers (TDL) offers the potential for rugged, compact, low-power consuming, and relatively low-cost sensors, and the potential for remote monitoring of real-time gas composition and temperature without the complications of intrusive gas sampling or temperature probes. The primary challenge of using TDL sensing to control coal gasification is the high pressure envisioned for practical coal gasification and how this high pressure complicates quantitative, species selective gas sensing by optical absorption. While the invention is being described with respect to coal gasification and reactors, it should be appreciated that the invention may be used in conjunction with other types of pressure vessels.

Until now, TDL sensing applications have focused on processes at or below atmospheric pressure. TDL absorption at high pressure is complicated by pressure broadening of the absorption features, which makes interpretation of the results extremely difficult in chemically reactive environments such as coal gasifiers.

The transmission of the TDL light through a gasifier is strongly attenuated by optical scattering from the particulate (such as fly ash and char fines). As such, a wavelength-multiplexed TDL sensor was designed to measure temperature from water vapor absorption. These measurements achieved excellent temperature measurement uncertainty (approx 3%) in the freeboard of a fluidized bed reactor, even when less than 5% of the beam intensity was transmitted through the char fines produced by black liquor gasification.

Due to the chemically reactive and slagging environment in a coal gasifier, optical access into coal gasifiers can be a challenge. However, most of the experience is with large view ports designed to allow the operator to view the environment—the TDL sensor requires a much smaller access. The laser beam is typically collimated to a few millimeters diameter, although a large 1 cm diameter may provide even more robust measurements in the presence of particulate scattering. Thus, a window of this size can more readily be kept clean by gas purging than feasible for large visualization windows.

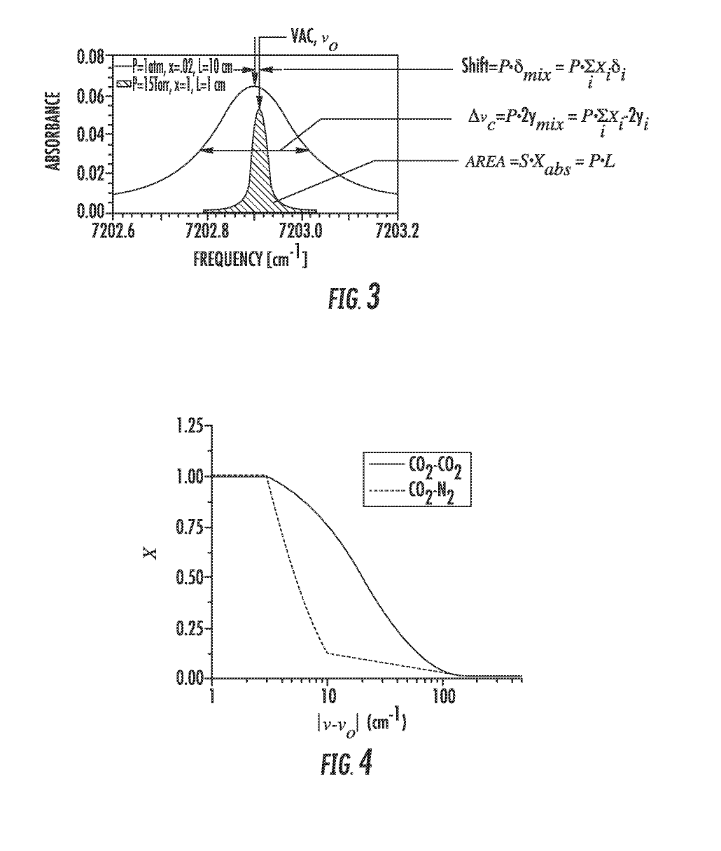

Referring to the drawings, an exemplary wavelength-multiplexed diode laser absorption sensor according to an embodiment of the invention is illustrated in FIG. 2 and shown at reference numeral 10. The wavelength-multiplexed diode laser absorption sensor 10 uses individual lasers 11-14 with wavelengths selected to target the gas temperature via a ratio of absorption for two transitions of H₂O and to target the important gas species (for example, for O₂ blown systems the heating value of the gasifier output stream could be estimated from simultaneous measurement of CH₄, CO, CO₂, and H₂O while assuming the balance of the gas is H₂).

The fundamentals of absorption spectroscopy are presented below. The simplest form of absorption spectroscopy is direct absorption spectroscopy, in which monochromatic light (such as from a laser), having a frequency of v, is passed through the test gas region to a detector and the attenuation of the light is quantified by the Beer-Lambert law, which relates the transmitted intensity Iₜ through a uniform gas medium of length L [cm] to the incident intensity I₀ as

$${( \frac{{I}_{t}}{{I}_{o}} )}_{v} = exp ( - {k}_{v} L ) ,$$

where kᵥ [cm⁻¹] is the spectral absorption coefficient, with kᵥ=Px_{abs}Sᵢ(T)øᵥ for an isolated transition, where P [atm] is the total pressure, x_{abs} the mole fraction of the absorbing species, Sᵢ(T) [cm⁻²atm⁻¹] the linestrength of the transition at temperature T [K], and øᵥ [cm] the lineshape function. The product of kᵥL is called the spectral absorbance

$${α}_{v} ≡ - {ln ( \frac{{I}_{t}}{{T}_{o}} )}_{v} = {k}_{v} L = {Px}_{abs} {S}_{i} ( T ) {φ}_{v} L .$$

The lineshape function øᵥ is normalized such that

$${\int }_{- ∞}^{∞} {φ}_{v} d v ≡ 1$$

and the integrated absorbance [cm⁻¹] can be expressed as

$${A}_{i} = {\int }_{- ∞}^{∞} {α}_{v} d v = {Px}_{abs} {S}_{i} ( T ) L .$$

With knowledge of the linestrength at a reference temperature, S(Tₒ), and the lower state energy of the transition E″ [cm⁻¹], the linestrength at an arbitrary temperature S(T) can be calculated using the following scaling relation

$$S ( T ) = S ( {T}_{o} ) \frac{Q ( {T}_{o} )}{Q ( T )} ( \frac{{T}_{o}}{T} ) {exp [ - \frac{{hcE}^{″}}{k} ( \frac{1}{T} - \frac{1}{{T}_{o}} ) ] [ 1 - exp ( \frac{- {hcv}_{o}}{kT} ) ] [ 1 - exp ( \frac{- {hcv}_{o}}{{kT}_{o}} ) ]}^{- 1} ,$$

where h [J·s] is Planck's constant, c [cm/s] the speed of light, k [J/K] Boltzmann's constant, Q(T) the partition function of the absorbing molecule, and v₀ [cm⁻¹] the line-center frequency of the transition. It follows that the ratio of absorption measured on transitions with different internal energy (E′) provides a simple means to infer the gas temperature. For the high-pressure gasifier application, the absorption transitions of neighboring lines are blended by collisional broadening. However, we have demonstrated the ability to extract precise temperature from the ratio of absorption measured at two selected wavelengths in spectra blended by pressure broadening when the pressure is known.

The pressure-broadened lineshape function øᵥ is illustrated in FIG. 3, and this “Voigt profile” is characterized by the collisional full-width at half maximum (FWHM) Δv_{c} [cm⁻¹] and Doppler FWHM Δv_{d}[cm⁻¹], where M [g/mol] is the molecular weight of the absorbing species. The collisional FWHM Δv_{c} is proportional to the system pressure:

$$Δ {v}_{c} = P {\sum }_{j} {x}_{j} 2 {γ}_{j - abs} .$$

Here Y_{j-abs} [cm⁻¹atm⁻¹] is the broadening coefficient due to the collisions between perturbing species j and the absorbing species. The temperature dependence of the collisional broadening coefficient yⱼ can be expressed:

$${γ}_{j} ( T ) = {γ}_{j} ( {T}_{o} ) {( \frac{{T}_{o}}{T} )}^{n} .$$

At atmospheric pressure the collisional contribution to the linewidth dominates the Doppler width, and thus, collisional broadening constants are required to estimate the transition linewidth. For pressures of 25-50 atm in the gasifier, the pressure broadening is larger than the typical line spacing and the absorption at each wavelength is simply the sum of contributions from many pressure-broadened transitions. Thus, accurate collisional-broadening data for yⱼ are essential to simulate the absorption spectrum at gasifier conditions.

The center frequency of the transition is also shifted by the perturbations in the molecular potential caused by collisions between molecules that result in changes in the energy level spacing. This pressure-induced frequency shift Δvₛ [cm⁻¹] is proportional to the system pressure as

$$Δ {v}_{s} = P {\sum }_{j} {x}_{j} {δ}_{j - abs} ,$$

and the shift coefficient δⱼ [cm⁻¹atm⁻¹] also has temperature dependence:

$${δ}_{j} ( T ) = {δ}_{j} ( {T}_{o} ) {( \frac{{T}_{o}}{T} )}^{m} .$$

Even though the pressure shift is small at atmospheric pressure, the collision shift of a specific transition can be either towards the red (longer wavelength) or blue (shorter wavelength), and because the absorption at any wavelength at the 25-50 atm pressure of the gasifier is the sum of contributions from many transitions, the pressure shift contribution becomes a relevant part of accurately simulating the absorption spectrum.

Therefore, quantitative interpretation of measurements at high pressure require a database including S(T) and E″ for each transition and a set of collisional parameters yⱼ, n, δⱼ, and m for each collision partner. At high pressures, data are required not only for the target transition, but for all of the transitions that contribute by collisional broadening at a specific wavelength. At atmospheric pressure, near-IR absorption transitions of small molecules are well isolated with a FWHM ranging from 0.05-0.3 cm⁻¹; however, pressure broadening increases the FWHM at 50 atm to values ranging from 2.5-15 cm⁻¹, which blend the absorption coefficient into a structured continuum.

Fortunately, for CH₄, CO, CO₂, and H₂O this database has been constructed and available electronically on the internet. The spectral parameters (S, line-broadening coefficients, pressure-induced shift coefficients, etc.) for many molecules have been studied and catalogued into databases such as HITRAN 2004, making it possible to use the Beer-Lambert relation to simulate spectra for a variety of gas conditions. An unknown gas property can be inferred by comparing the measured light attenuation at one wavelength with simulated spectra as a function of the unknown property, one can then solve for the unknown gas property (T, xᵢ, or P). Multiple unknown gas properties can be determined using the attenuation at multiple wavelengths.

Unfortunately, high temperature data of the spectral parameters are generally not available and experiments must be performed to establish a valid database for quantitative measurements at the conditions expected in the gasifier. Similarly the high pressure data needed for collision partners not important in air (for example, CO) must be measured for the target transitions. In addition, at these high pressures, the Lorentzian lineshape description of absorption transitions is no longer valid.

Direct absorption spectroscopy becomes difficult in high-density environments when the zero-absorption ‘baseline’ between distinct spectral features becomes obscured by the broadened and blended wings of adjacent features. The baseline is necessary to determine the incident laser intensity (Iₒ), which can be changing with time due to laser power drift, window fouling, beam steering, and scattering. Thus in high-density environments, direct absorption spectroscopy must rely on differential absorption techniques, the use of lasers at spectrally-distant non-resonant wavelengths to track the baseline, or a stable measurement environment in which the incident laser intensity is not changing.

The environment at the exit of the gasification reactor is especially harsh, consisting of a variable gas composition, high temperature (800-1900 K), and high pressure (25-50 atm). Although many research groups have explored TDL sensing at atmospheric and sub-atmospheric pressures, there is a paucity of published efforts to extend TDL sensing to high-pressure practical combustion applications. This limitation of TDLs to near atmospheric-pressure applications occurs because of the limited wavelength tuning range of typical diode lasers, and the difficulty of measuring and simulating pressure-broadened and blended spectra. We have solved this problem with our wavelength-multiplexing concept, which uses multiple diode lasers, and have made measurements at the high pressures found inside the cylinder of IC-engines and behind detonation waves.

Wavelength modulation spectroscopy with second harmonic detection (WMS-2f) is similar to direct absorption spectroscopy, except the laser wavelength is rapidly modulated and the resulting detector signal is passed through a lock-in amplifier to isolate only the frequency components of the detector signal at the second harmonic of the modulation frequency. Like direct absorption, the WMS-2f signal is dependent on spectral parameters and gas properties and can therefore be compared with spectral simulations to infer gas properties. However, WMS-2f has several benefits which make it desirable over direct absorption for certain sensing applications.

The WMS-2f signal is sensitive to curvature rather than absolute absorption levels, which is useful for high-density spectra, particularly those that are affected by the breakdown of the impact approximation. The use of a lock-in amplifier serves to reject noise that falls outside the pass band, such as laser intensity and electronic noise. The WMS-1f signal, which is obtained by passing the detector signal through a lock-in tuned to the first harmonic of the modulation frequency, is proportional to the incident laser intensity and therefore normalization of the WMS-2f signal by this signal can account for perturbations to the laser intensity by laser drift, window fouling, beam steering, or scattering. Most importantly, it has been shown recently that the use of 1f-normalization and inclusion of laser-specific tuning parameters into the WMS simulation models makes calibration-free measurements using WMS possible.

It should be noted that there are several drawbacks to WMS. Signal interpretation is more difficult with WMS since the model is more complex than the Beer-Lambert relation and includes assumptions that the spectroscopist must ensure are appropriate for the experiment. In addition, the WMS-1f signal is moderately affected by absorption, meaning an estimate of the nominal conditions within the test gas is necessary to reduce error in the WMS-1f model when using 1f-normalized WMS-2f to infer unknown properties in environments with large absorbance.

The WMS-2f signal is described by,

$${S}_{2 f} = {\frac{G \overline{{I}_{o}}}{2} [ \begin{matrix}{( \begin{matrix}{H}_{2} + \frac{{i}_{o}}{2} ( {H}_{1} + {H}_{3} ) cos {ψ}_{1} + \\ {i}_{2} ( {H}_{o} + \frac{{H}_{4}}{2} ) cos {ψ}_{2}\end{matrix} )}^{2} + \\ {( \begin{matrix}\frac{{i}_{o}}{2} ( {H}_{1} - {H}_{3} ) sin {ψ}_{1} + \\ {i}_{2} ( {H}_{o} - \frac{{H}_{4}}{2} ) sin {ψ}_{2}\end{matrix} )}^{2}\end{matrix} ]}^{\frac{1}{2}}$$

where G is the optical-electrical gain of the detector, Iₒ is the average laser intensity, and iₒ and i₂ represent the linear and first term of the nonlinear intensity modulation amplitude, normalized by Īₒ. The terms ψᵢ and ψ₂ represent the phase shift between the intensity modulation and frequency (wavelength) modulation. It is assumed that the so-called zero-absorption background signal, which is caused by the nonlinear intensity modulation, has been measured in the absence of absorption and vector subtracted from the WMS-2f signal in the presence of absorption.

The WMS-1f signal is given by,

$${R}_{1 f} = {\frac{G \overline{{I}_{o}}}{2} [ \begin{matrix}{( {H}_{1} + {i}_{o} ( 1 + {H}_{o} + \frac{{H}_{2}}{2} ) cos {ψ}_{1} + \frac{{i}_{2}}{2} ( {H}_{1} + {H}_{2} ) cos {ψ}_{2} )}^{2} + \\ {( {i}_{o} ( 1 + {H}_{o} - \frac{{H}_{2}}{2} ) sin {ψ}_{1} + \frac{{i}_{2}}{2} ( {H}_{1} - {H}_{3} ) sin {ψ}_{2} )}^{2}\end{matrix} ]}^{\frac{1}{2}}$$

The use of the symbol R (as opposed to S conforms with the convention of and denotes background subtraction has been performed (or is necessary) with the WMS-1f signal. The Hₖ terms can be represented by

$${H}_{o} ( T , {P}_{i} , \overline{v} , a ) = \frac{1}{2 π} {\int }_{- π}^{π} exp \{ - {\sum }_{j} {S}_{j} ( T ) \cdot {φ}_{j} ( T , P , x , \overline{v} , + a cos θ ) \cdot P \cdot {x}_{i} \cdot L \} d θ$$

$${H}_{k} ( T , {P}_{i} \overline{v} , a ) = \frac{1}{π} {\int }_{- π}^{π} exp \{ - {\sum }_{j} {S}_{j} ( T ) \cdot {φ}_{j} ( T , P , x , \overline{v} , + a cos θ ) \cdot P \cdot {x}_{i} \cdot L \} cos k θ d θ$$

where v̅ is the average laser optical frequency and a is the amplitude of the frequency (wavelength) modulation. These Hₖ terms do not make any assumption about optical thickness and can be used for all conditions.

It is well-known that as density increases, the impact approximation inherent to the Lorentzian line shape profile for pressure-broadened spectral features breaks down. This is due to the increased importance of finite-duration collisions, which particularly affect far-wing absorption. As shown by Winters et al and later by Burch et al, this effect is manifest by lower measured absorbance in the far-wings of CO₂ features than predicted by the Lorentzian profile. Several researchers developed empirical corrections to the Lorentzian profile based on low-temperature (193-296 K), near-atmospheric data in the 4.3 μm region. These corrections are applied through a frequency-dependent _{X}-function that is multiplied with the line shape function of individual absorption features.

Perrin and Hartmann coupled the data of Doucen, Menoux, Cousin, and Doucen with their own data at 4.3 μm in gases up to 60 atm and 800 K to develop a temperature and frequency-dependent _{X}-function for CO₂-CO₂ and CO₂-N₂ collisions. This model was used by Scutaru et al at elevated temperatures (<800 K) and low pressures (<1 atm) for the 4.3 and 2.7 μm region.

Good agreement was found at 4.3 μm, however the _{X}-functions had very little effect for the particular spectra and conditions used for the 2.7 μm data and thus provided little useful information on accuracy there. The model was tested in the 2.3 μm window region by Tonkov et al for pure CO₂ at high pressure (to 50 atm) and room temperature. They found that the _{X}-functions under-predicted the absorption and proposed new factors. However, the researchers believe the largest influence in the 2.3 μm region is the bands in the 2.7 μm region and that the new factors likely also account for several local effects which influence the window region (weak allowed bands, collision-induced absorption, etc.). Theoretical approaches based on first-principles calculations have been proposed first for CO₂ broadened by simple perturbers (for example, Argon) and later for self-broadened CO₂, however, these approaches require large computing resources and are not yet applicable to CO₂-N₂ mixtures.

The model of Perrin and Hartmann was chosen for this work because it contains the most recent formulation for CO₂-N₂ mixtures. The analytical expressions for the _{X}-functions used in this work are shown in Table 1 below.

TABLE 1

| \|Δν\| (cm⁻¹) | | χ(Δν, T) |
|---|---|---|
| CO₂—CO₂ | CO₂—N₂ | |
| 0 < \|Δν\| < σ₁ = 3 | 0 < \|Δν\| < σ₁ = 3 | 1 |
| σ₁ < \|Δν\| < σ₂ = 30 | σ₁ < \|Δν\| < σ₂ = 10 | exp[−B₁ * (\|Δν\| − σ₁)] |
| σ₂ < \|Δν\| < σ₃ = 120 | σ₂ < \|Δν\| < σ₃ = 70 | exp[−B₁ * (σ₂ − σ₁) − B₂ * |
| | | (\|Δν\| − σ₂)] |
| \|Δν\| > σ₃ | \|Δν\| > σ₃ | exp[−B₁ * (σ₂ − σ₁) − B₂ * |
| | | (σ₃ − σ₂) − B₃ * |
| | | (\|Δν\| − σ₃)] |

The temperature-dependence of the _{X}-functions is introduced through the analytical law for calculating B₁, B₂, and B₃:

Bi(T)=αi+βi exp(−εiT)

where the coefficients α, β, and ε are found in Table 2.

TABLE 2

| CO₂—CO₂ | | | | CO₂—N₂ | | | |
|---|---|---|---|---|---|---|---|
| | α | β | ε | | α | β | ε |
| B1 | 0.0888 | −0.160 | 0.00410 | B1 | 0.416 | −0.354 | 0.00386 |
| B2 | 0 | 0.0526 | 0.00152 | B2 | 0.00167 | 0.0421 | 0.00248 |
| B3 | 0.0232 | 0 | 0 | B3 | 0.0200 | 0 | 0 |

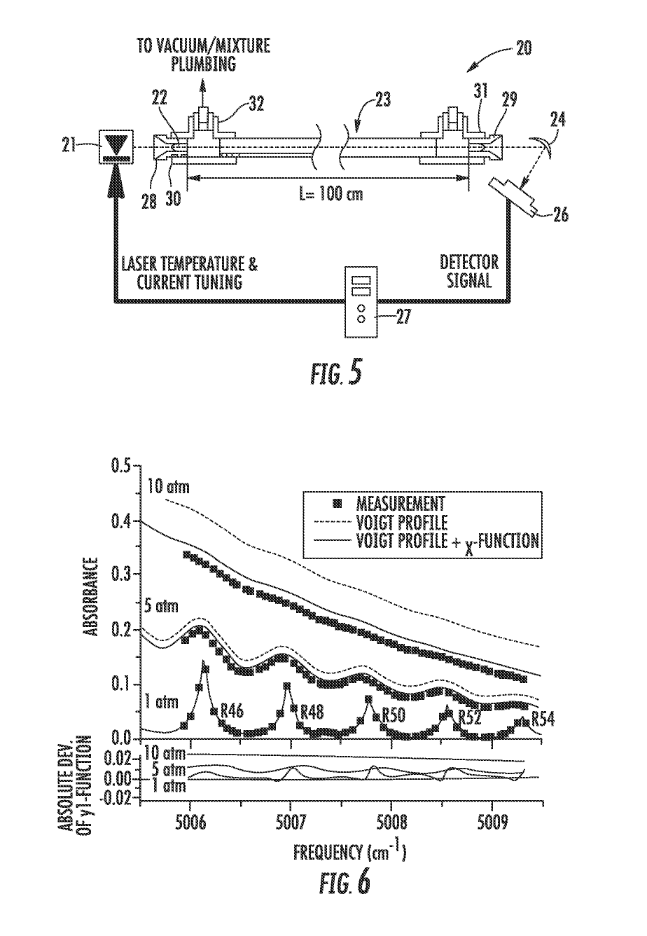

FIG. 4 is a plot of the x-functions versus frequency de-tuning from line center for CO₂-CO₂ collisions and CO₂-N₂ collisions at 296 K. When the _{X}-functions are multiplied with the Voigt line shape profile, the effect is to reduce the overall line shape function in the far-wing of individual features.

In addition to a good line shape model, measurements in high-pressure environments require an accurate database of spectroscopic parameters. HITRAN 2004 is a large compilation of calculated and measured spectral parameters for many species. In terms of CO₂, HITRAN 2004 includes line positions, strengths, lower-state energies, and broadening parameters, however, it does not include pressure-induced shift coefficients. Recently, Toth et al performed an extensive experimental survey of CO₂ absorption from 4500-7000 cm⁻¹. The measurements and modeling include line position and strength, self-broadening and self-induced pressure shift coefficients, and air-broadening and air-induced pressure shift coefficients. The line strength coefficients of Toth et al are within 3% and the self-broadening coefficients are within 6.8% of measurements in the 5005-5010 cm⁻¹ region by Webber et al. The Toth et al coefficients are also in general agreement with line strength, broadening, and pressure shift measurements by Corsi et al in the 4990-5005 cm⁻¹ region.

In order to confirm and produce additional data, tests were completed using an experimental setup 20 like that shown in FIG. 5. In setup 20, light from a fiber-coupled diode laser 21 emitting near 1.997 μm (5008 cm−1) is passed to a fiber-collimator 22 and sent through a test cell 23. Despite being well outside the optimal wavelength range for the collimator 22, an acceptably small divergence angle was achieved to maintain a relatively small beam diameter across the 100 cm length of the test cell 23. A spherical mirror 24 collects the beam onto a room temperature extended-In-Gas detector 26. The detector signal was sent through an 8-pole low-pass Butterworth analog filter (not shown) before digital sampling by a multifunction data acquisition card in a desktop PC 27. The signal was stored raw and later analyzed using a software lock-in amplifier. The laser modulation was provided by the same PC and multifunction card.

The static optical cell 23 is stainless steel with interchangeable body sections to form different pathlengths, for example, 100 cm. Tapered sapphire windows 28, 29 with 1 cm open aperture are epoxied in the cell end caps 30, 31. Each surface has a 1° wedge to avoid creating an etalon within or between the windows 28 and 29. A vacuum system and mixture tank (not shown) are connected via a stainless manifold 32. Temperature is measured with three type K thermocouples and pressure is determined with 1000 or 10000 torr Baratron capacitance manometers.

The average injection current of the diode laser is held constant (with rapid current modulation superimposed for WMS) and the laser thermoelectric cooler (TEC) is used to vary the laser temperature, thereby tuning the average laser wavelength across the spectral region of interest. The laser control and data acquisition process is automated using Labview and a GPIB controller in communication with the laser controller. The optical cell 23 is first filled with pure, dry air to the desired experimental pressure. The incident laser intensity (Iₒ) for the direct absorption spectra and the zero-absorption background for the WMS spectra are obtained by running the automated program once with the cell filled with this non-absorbing medium. The program tunes the laser to a temperature setpoint, waits for the laser to stabilize and acquires several seconds of the detector signal. The rapid modulation is turned on for WMS, the laser again stabilizes, and the detector signal is acquired. The modulation is turned off, the laser is moved to the next temperature set-point, and the process is repeated for each data point. The cell 23 is then evacuated and filled with the CO₂/air mixture to the desired experimental pressure, and the process repeated to obtain the transmitted laser intensity (Iₜ) for the direct absorption spectra and the absorbing WMS signal.

Prior to and after the completion of data collection, the automated process was repeated with the laser output directed to a wavemeter to obtain the calibration between laser temperature set-point and wavelength. Unlike the results reported for a similar process using NIR diode lasers near 1.4 μm for high pressure measurements of H₂O [Rieker high P], this particular diode laser did not exhibit wavelength shift due to modulation. This may be due in part to the lower modulation depth used with this laser. All WMS spectra reported in this paper uses modulation depth a=0.11 cm−1 and modulation frequency f=50 kHz.

The direct absorption spectra was presented and compared with simulations using the database of Toth et al. with (1) an unmodified Voigt line shape profile and (2) a Voigt line shape profile modified by the _{X}-functions of Perrin and Hartmann. The Voigt profile was chosen over the Lorentzian profile for accuracy at lower pressures, however even at 1 atm the Voigt profile is dominated by the Lorentzian component. FIG. 6 shows the experimental results plotted with the simulations. The measured spectra covers the R46 through R54 lines of the 20012←00001 band of ¹²C¹⁶O₂ centered at 4978.6 cm⁻¹. The dashed lines represent the simulations using only the Voigt profile and the solid lines denote the simulations which include the _{X}-functions. At 1 atm the difference between the simulations is negligible, however as pressure increases, the rising difference results from the far-wing influence of the stronger features to the red of the measured spectra. The average error in this region is reduced by application of the _{X}-function from 24% to 8.5% for the 5 atm spectrum and from 40% to 10% for the 10 atm spectrum.

The remaining error is the result of several factors. The Perrin and Hartmann _{X}-functions were developed with data from the 4.3 μm region of CO₂. The measurements of Burch et al. on the 4.3, 2.7, and 1.4 μm regions of CO₂ show that the influence of finite-duration collisions on the Lorentzian line shape decreases with wavelength for the various bands. This would suggest that the _{X}-function developed at 4.3 μm should under-predict the absorption measured at 2.0 μm. Also, the Perrin and Hartmann _{X}-function was developed using the GEISA database, and though it was tested and gave good agreement with the HITRAN 86 database, many updates have been made in the years since and with the Toth database used here.

Finally, the _{X}-function of Perrin and Hartmann does not include super-Lorentzian corrections in the intermediate-wing of the absorption feature. These corrections become important near absorption bands, where effects such as line mixing “transfer intensity from regions of weak absorption to those of strong absorption”. An example of this effect is shown in [Rieker high P], where super-Lorentzian behavior is reported and accounted for using the _{X}-function for H₂O developed by Clough et al., which includes super-Lorentzian effects.

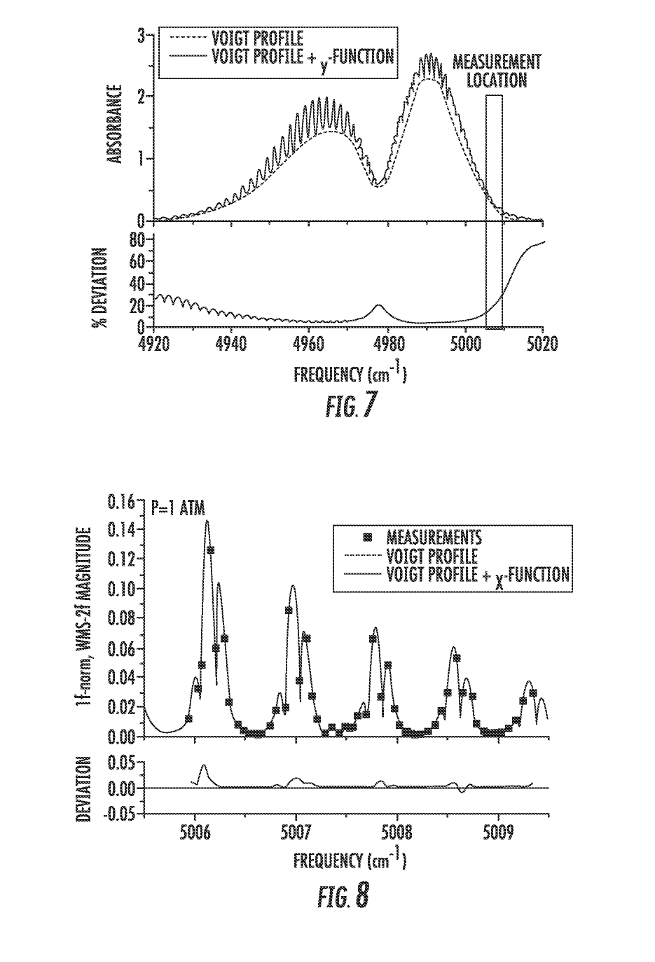

The simulated absorbance with and without the _{X}-function for the entire 20012←00001 band is shown in FIG. 7 with the measurement region for FIG. 6 demarcated. One can see the measurement region is near the edge of the band. It is therefore hypothesized that the slight overprediction of absorbance in this region by the _{X}-function is the compound result of under-prediction of super-Lorentzian effects in the intermediate-wings of nearby features and over-prediction of sub-Lorentzian effects due to finite-duration collisions.

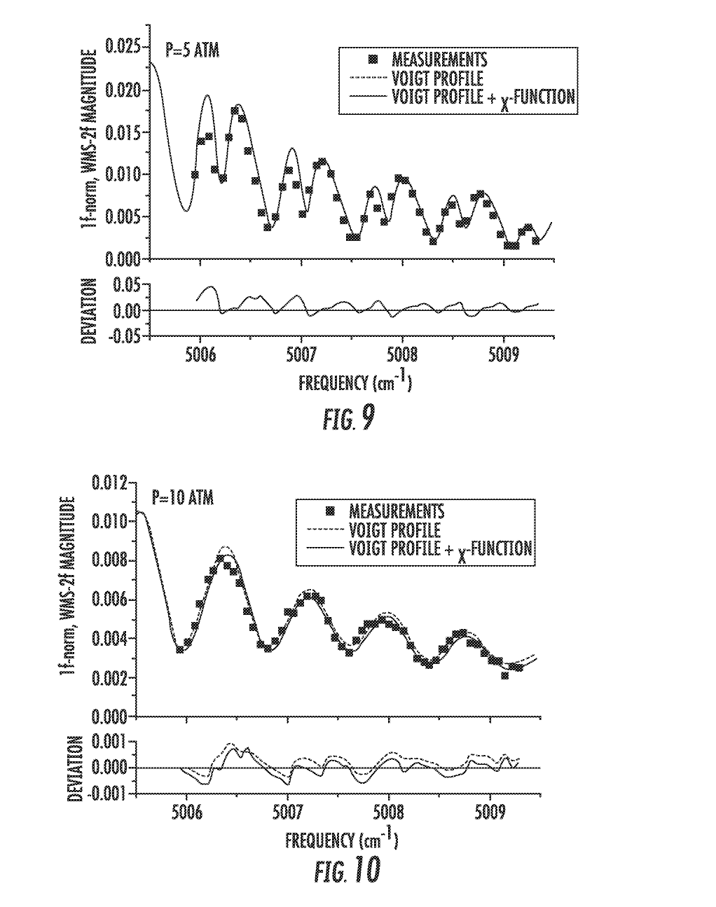

The WMS results are shown in FIGS. 8-10 for 1, 5, and 10 atm, respectively. At 1 atm, good agreement is obtained between simulation and experiment and the non-Lorentzian effects are too subtle to play a noticeable role. For the 5 atm case, good agreement is obtained and again the _{X}-function shows little effect on the simulated spectra. However, a slight frequency shift between the experiment and both simulations is apparent. This discrepancy is apparent in the 10 atm case as well. Analysis reveals that augmenting the average pressure-induced shift coefficient by −0.004 cm⁻¹/atm provides improved agreement at all pressures. This falls outside the reported uncertainty of the pressure shift coefficients in Toth et al., however one should note that shift coefficients are very difficult to accurately measure at the low pressures employed for spectral validations and often uncertainties for spectral parameters are calculated from fitting uncertainties, which do not take systematic error into account.

At 10 atm, the effect of c-function corrections to the line shape becomes apparent in the simulated spectrum, but the effect is quite small. Table 3 summarizes the effect of non-Lorentzian behavior on the WMS and direct absorption signals at all pressures. The percentage differences in Table 3 were calculated by taking the difference between the simulations with and without the _{X}-function and comparing with the _{X}-function corrected case. The reported result is the average for the region between 5005.5 and 5009.5 cm⁻¹.

TABLE 3

| | Average % effect of | | |
|---|---|---|---|
| | non-Lorentzian | | |
| | behavior on signal* | | |
| | 1 atm | 5 atm | 10 atm |
| WMS-2f | 0.3 | 1.5 | 4.6 |
| WMS-1f | 0.1 | 1.5 | 5.7 |
| 1f-norm, WMS-2f | 0.3 | 0.8 | 6.3 |
| Direct Absorption | 6.7 | 13.8 | 27.1 |

*With respect to χ-function corrected signal

One can immediately see that the WMS signals are much less affected by non-Lorentzian behavior than direct absorption. The WMS-2f signal is sensitive to curvature, and therefore the difference in the WMS-2f signal between the simulations arises from slight variation in the curvature of the spectrum due to the non-Lorentzian effects. The difference in the influence of the non-Lorentzian effects on the direct absorption and WMS-1f signals is due to the different dependences on absolute absorption between the two. The direct absorption signal is the absorbance, so if for example, the absorbance at 5007.5 cm⁻¹ is modeled as 28.2% for the unmodified Voigt and 22.4% for the _{X}-function modified Voigt, the direct absorption signal experiences a 26% effect due to non-Lorentzian effects. The WMS-1f signal is approximately proportional to (1-absorbance). Therefore for the same example above, we expect the WMS-1f signal to change by ˜7.5% due to non-Lorentzian effects. Indeed the actual simulations show that it changes by 5.7%.

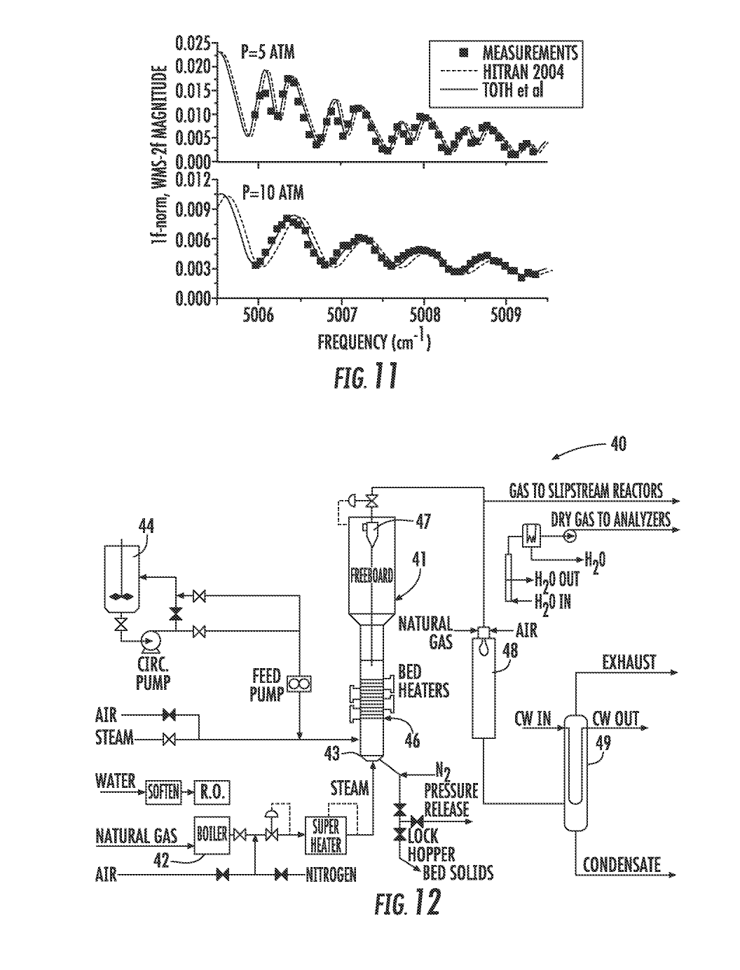

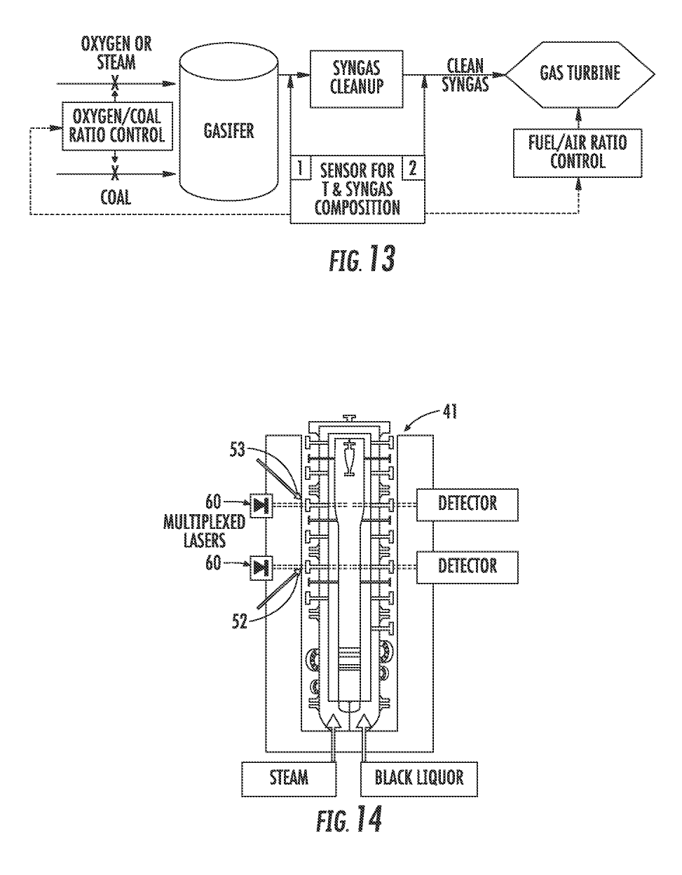

A quantitative comparison between spectral databases cannot be carried out with direct absorption spectra at high pressures because the effect of non-Lorentzian behavior is large and the _{X}-function corrections carry large uncertainty. We have shown here that the use of WMS reduces the effects of non-Lorentzian behavior, so even though there are larger uncertainties in the WMS models than the Beer-Lambert relation for direct absorption, WMS provides a method to make accurate comparisons between spectral databases at high pressures. FIG. 9 shows the WMS data at 5 and 10 atm with simulations using the Toth database and the HITRAN 2004 database with a _{X}-function modified Voigt profile. The comparison shows that both databases give accurate values for the linestrengths and broadening coefficients at room temperature, however the lack of pressure-induced shift coefficients in the HITRAN 2004 database induce significant error in the simulations.

### EXAMPLE 1

Testing of TDL absorption for gas temperatures was conducted using a pressurized, pilot-scale, bubbling fluidized-bed gasifier/reactor using absorption transitions of water vapor in the near-infrared, which can be accessed by robust telecommunications diode lasers. Measurements were made in the reactor freeboard during the gasification of black liquor where the char particulate attenuated the transmitted beam intensity by more than 90%. Measurements were also made in the splash zone above the bed (without black liquor fuel), where the motion of the bed particulate produced rapid time-varying transmission. Successful temperature measurements in the presence of strong overall attenuation as well as rapid time variation of the transmitted intensity, provide proof-of concept for the use of TDL absorption as a time-resolved temperature (and gas composition) diagnostic for application to coal gasification.

Referring to FIG. 12, gasification system 40 includes a pressurized fluidized bed reactor 41 plus associated inlet feed and product handling subsystems. Both the fluidizing and reacting gas are steam delivered up to 130 kg/hr (286 lb/hr) by a natural gas-fired boiler 42. Before injection into a distributor 43 of the fluidized bed reactor 41, the steam is electrically super-heated to 625° C. (1157° F.). While the system 40 was designed to process spent pulping liquor (black liquor), it may also be modified to allow feed of solid biomass. For the experiments reported here, concentrated black liquor from a 150 gallon electrically heated tank 44 is pumped by a high temperature peristaltic pump into a steam-assisted injector, which feeds the liquor into the reactor 41 between the distributor 43 and a bottom heater bundle 46.

The reactor 41 is rated to 2 MPa (300 psi) and contains a 1.5 m (59 in) high and 0.25 m (10 in) diameter bed section with eighty 1.6 cm (0.63 in) diameter horizontal heaters in four bundles of 20 heaters. These heaters have a total maximum heat input of 32 kW and are necessary to drive the pyrolysis and gasification that takes place in the reactor. The freeboard section above the bed is 3m (10 ft) in height and expands from 0.25 m (10 in) to 0.36 m (14 in) halfway up to reduce gas velocity and limit particle entrainment. An internal cyclone 47 at the top of the reactor returns particulate matter to the bed through a dipleg. The bed region contains six thermocouples at various locations. The freeboard region contains three additional thermocouples evenly spaced across the length of the freeboard.

The product gas from the reactor 41, which contains primarily hydrogen, carbon monoxide, and methane, is fed to a 117kW (400,000 Btu/hr) natural gas-fired afterburner 48 to burn combustible species and destroy any condensable hydrocarbon “tars” in the gas. The flue gas from the afterburner 48 passes through a cooler/condenser system 49 and into the facility's flue gas cleaning and exhaust system (not shown). A continuous product gas analyzer (not shown) indicates and records concentrations of H₂, CO, CO₂, and CH4 in the dry product gas and a micro process GC semi-continuously records 18 species in the product gas. The entire system is monitored and controlled by an integrated control system, which includes safety systems for intelligent shutdown in case of an undesirable event (e.g., power failure cooling water loss). System temperatures, pressures, flow rates and gas composition are also recorded.

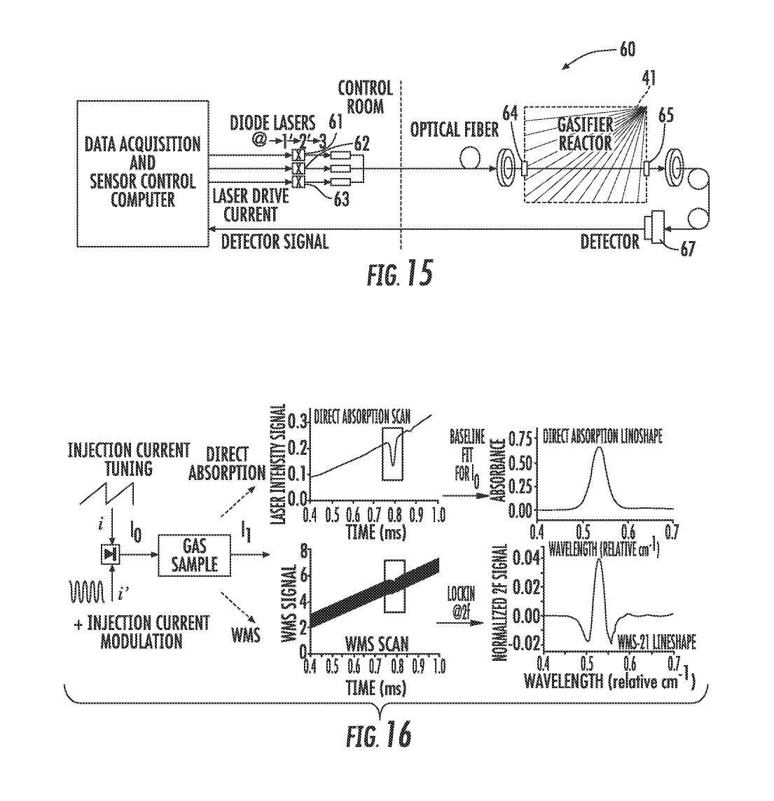

Two sensor applications were implemented: Temperature to control the gasifier and gas composition at the gasifier exhaust to provide a heating value of the output gas stream. These sensors may provide control inputs to optimize the operation of the gasifier and the gas turbine, respectively. FIG. 13 illustrates potential locations for gas sensors for a combined cycle power plant.

As illustrated in FIG. 14, two measurement stations (measurement ports 52, 53) were utilized in the refractory-lined reactor 41 to conduct sensor performance tests. The lower measurement port 52 was located in the bed section near the top of the splash zone, and the upper measurement port 53 was located within the freeboard.

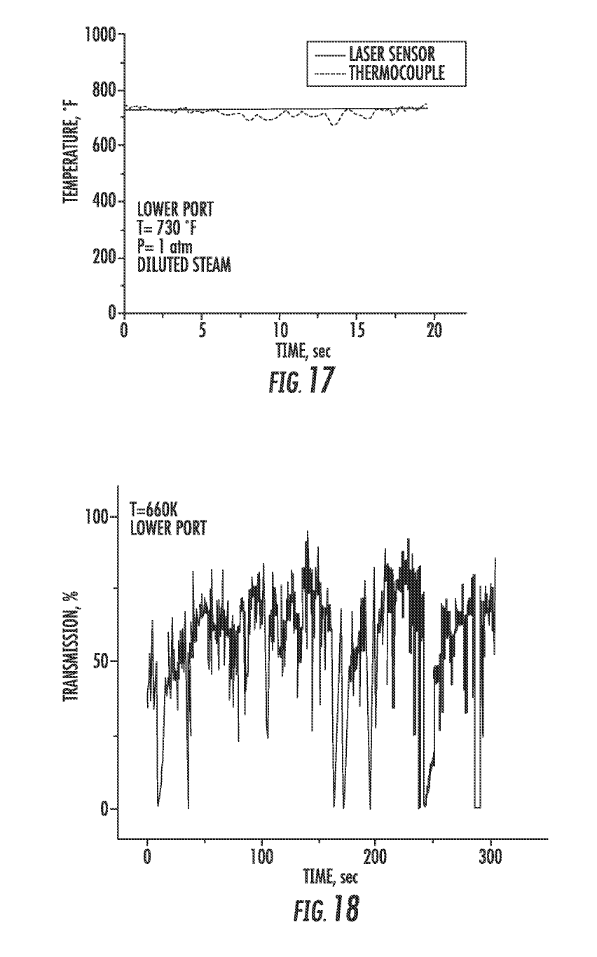

The experiments conducted in the particulate-laden reactor 41 targeted two absorption features in H₂O using robust telecommunications diode lasers in the TDL sensor 60, FIG. 15. The TDL sensor 60 includes two lasers 61, 62 operating near 1398 and 1469 nm and a third laser 63 operating near 1310 nm which is free of H₂O absorption to determine losses by particulate scattering for the direct absorption experiments. As shown (with reference to port 52), light from the diode lasers 61-63 is combined onto a single fiber and transmitted the 30 m to the reactor 41. The light is then lens collimated and directed through windows 64, 65 across the reactor 41 (See FIG. 14) using an optical mount on the reactor window flange. The transmitted light is collected onto a multi-mode fiber, directed to a detector 67 a few meters from the reactor 41, and the detector signal is transmitted to a control room for data collection.

Transmission of light from the TDL sensor 60 in lower port 52 is attenuated by scatter from the splash of bed particulate (˜200 micron diameter). As seen, the transmission rapidly varies with time, yet successful temperature measurements (<3% statistical uncertainty) were achieved, even for optical transmission of only a few percent. Light transmission of light from TDL sensor 60 in upper port 53 is attenuated by scattering for the char fines (˜10 micron particulate) from the gasification of black liquor. Again successful temperature measurements were achieved for small fractional optical transmission. If the transmission in the entrained flow reactor becomes a problem, there is the potential to significantly increase the transmitted laser power. For the measurements reported here, laser power is less than 10 mW per laser. This value can be increased by a factor of as much as 100 using a fiber amplifier, if the particulate attenuation becomes a problem.

Absorption of narrow-linewidth light is described by the Beer-Lambert law:

$${T}_{v} = {( \frac{I}{{I}_{o}} )}_{v} = exp ( - S φ {P}_{i} L ) = exp ( - {k}_{v} L )$$

where Tᵥ is the fractional transmission, I and lₒ are the incident and transmitted intensities at frequency v, S is the line strength, ø is the lineshape function, P is the partial pressure of the absorbing gas, and L the path length through the absorbing media. The product SøPᵢL is called the spectral absorbance, and kᵥ is the spectral absorption coefficient. Because S and ø are functions of temperature T, it is necessary either to know T or to measure it in order to convert a measurement of Tᵥ to partial pressure of the absorbing species.

Gas temperature can be determined from the ratio of absorbance for two different absorption transitions of the same species with different lower-state energy values. When the temperature and gas composition variations are modest along the line-of-sight, this ratio provides a spatially averaged temperature, which can be a significantly more meaningful health monitor than a thermocouple probe embedded in the reactor wall. Once the temperature is known, either of the absorption signals can be used to determine the concentration of individual species. In addition, these TDL temperature measurements can be rapidly performed (measurement bandwidths greater than 10 kHz are feasible and a 2 kHz bandwidth was used for the measurements reported here). This allows measurements of temperature fluctuations, which offers a new potential to monitor process stability.

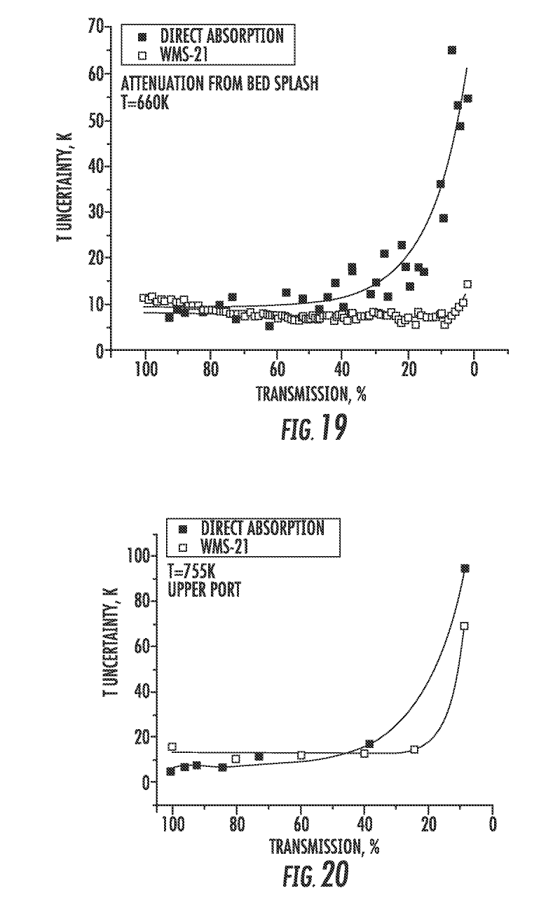

The TDL absorption measurements were performed using two different strategies: (1) wavelength-scanned direct absorption (DA) and (2) wavelength-scanned, wavelength-modulation spectroscopy (WMS). The direct absorption strategy is described in the upper half of FIG. 16. Here the injection current of the TDLs is linearly varied in time, producing a nearly linear change in wavelength and a simultaneous change in laser intensity. For the specific scan parameters, the laser frequency (v≡1/λ) vs injection current is characterized in the laboratory to convert the time scale to a scale of laser frequency. When the laser frequency is scanned through an absorption feature the transmitted intensity decreases; fitting a baseline to the changing laser intensity in the absence of absorption provides Iₒ and is used to calculate the absorbance versus laser frequency, FIG. 16. For DA measurements, the integral of the absorption feature provides a calibration-free measurement of mole fraction when the temperature is known.

In a high-pressure environment the collisions can broaden and blend the absorption spectrum making the determination of the baseline difficult. For the DA experiments, we use the relative transmission measurement of an additional laser with a wavelength far from any H₂O absorption and assume the particulate scattering losses are the same for both lasers to infer variations in Iₒ.

Wavelength-scanned WMS has long been recognized to improve the limits for the detection of small absorption signals. WMS with 2f detection is nominally a “zero background” technique, although there are background WMS signals from the non-ideal behavior of injection-current-tuned diode lasers. At elevated pressures, simple theories of absorption lineshapes break down as the absorbing molecule experiences a high rate of collisions. These effects are largest in the wings of a transition far from the center of the absorption feature; however, at high pressures the wings of many absorption features contribute to the direct absorption signal, complicating interpretation of high-pressure laser absorption. By contrast, WMS-2f signals are sensitive to lineshape and are strongest near the peak of structured transitions, with minimal contributions to the signal from wings of the neighboring absorption features. Thus, WMS-2f offers significant advantage to absorption detection at the elevated pressures, e.g., 50 atm, expected in practical gasifiers.

The lower half of FIG. 16 depicts wavelength-scanned WMS-2f with injection current tuned TDLs. In the figure, a linear tuning ramp of injection current is summed with a sinusoidal modulation; note that other wavelength scanning waveforms can be used (e.g., sawtooth or sinusoidal). The 2f signal sharply peaks near the line center as the frequency of the laser is tuned over the absorption transition, resulting in the typical 2f lineshape. Normalization of the WMS-2f signal with the WMS-1f signal allows quantitative absorption measurements without additional calibration, if the injection current tuning characteristics of the laser are measured in the laboratory. In addition, the 1f normalization accounts for non-absorption losses in the transmission of the laser and in the WMS experiments reported below will be used to account for the scattering losses due to particulate in the gasifier reactor.

Measurements were performed for a wide variety of operating conditions. First, the temperature was measured at the lower port 52 without bed material or black liquor fuel. Once the laser and detector had been mounted and aligned, transmission was measured while a 70:30 mixture of steam diluted with nitrogen was flowing through the reactor, at pressures up to 7 atm and temperatures of 750° F. These measurements served to test the integrity of the optical window ports, the stability of the optical alignment and other mechanical tests of the sensor engineering. Similar signal-to-noise was observed for all of the data for temperature measured by both direct absorption and 1f-normalized WMS-2f at these setup conditions; these observations could be explained as the fluctuations observed in the superheated steam flow. An example of the direct absorption data for diluted steam with a thermocouple reading of 730° F. is shown in FIG. 17. Importantly, the TDL sensor 60 has the measurement bandwidth to capture the temperature variations from the unsteady steam/nitrogen flow at these conditions. These data were collected with a 2 kHz sensor bandwidth, which were averaged and plotted in FIG. 17 with a 100 Hz bandwidth. The laser sensor data are in good agreement with the (slower) wall-mounted thermocouple.

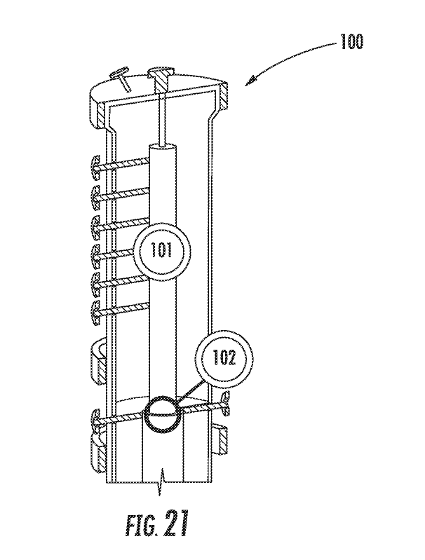

Once successful TDL temperature measurements were made in dilute steam for the range of pressure and temperature anticipated for the proof-of-concept tests, bed material was added to the reactor 41. The reactor flows were again steam diluted by nitrogen 70:30 (H₂O:N₂) with ˜1.2 ft/s superficial gas velocity through the bed. The beam path using the lower port 52 with 1.2 ft/s superficial gas velocity has only intermittent transmission as the large (˜200 μm diameter) bed particles block the beam; transmission measurements for the lower port 52 are shown in FIG. 18.

Although the transmission varied rapidly in time, the 2 kHz TDL temperature measurement bandwidth was sufficient to make time-resolved temperature measurements. The influence of transmission losses by particulate scattering is mitigated by normalization of the transmitted signals. The DA data are normalized by the transmission of the off-resonance laser, and the WMS-2f is normalized by the 1f signal. The measurements were binned as a function of transmission and the statistical uncertainty for temperature measurements with DA and WMS is plotted versus transmission in FIG. 19 for a temperature of 730° F. (660K) at a reactor pressure of 5 atm. The 1f-normalized WMS-2f is more robust than the normalized DA and has a 1-σ temperature uncertainty less than 30° F. (17K) for less than 5% transmission with a measurement time of 0.5 ms. This statistical scatter can be reduced by nearly a factor 10 by averaging to one second response time. Measurements in the upper port 53 with the bed material and without fuel were not significantly different than those in the lower port 52 without the splashing bed material.

Again the pressure was varied from 1 to 5 atm, and similar results were observed at all pressures tested. TDL sensor measurements were made in the upper port 53 during black liquor gasification; 50% solids black liquor from a carbonate process was fed into the system at a rate of 2.7 gallons per hour. In the reactor, black liquor produces a very friable, low-density char that is easily entrained into the freeboard region. During this mode of operation, the laser was significantly obscured by the particulate matter from the black liquor. FIG. 20 illustrates the normalized DA and WMS-2f temperature uncertainties as a function of transmission. The 1f-normalized WMS-2f temperature uncertainty did not degrade until less than 20% transmission. Although time-averaging reduced the statistical scattering, the reduction was less than predicted based on a shot-noise analysis. It is important to use sufficient purge flow to remove water vapor in the portion of the optical path through the reactor insulation. For the upper (freeboard) port 53, the pressure was varied from ˜15 psia to ˜75 psia with only a small variation in sensor performance (<10% change in statistical uncertainty).

Although optical transmission was obscured by the splash of 200 μm bed material in the lower port 52 and by much smaller char produced by black liquor gasification in the upper (freeboard) port 53, temperature measurements could be made with excellent precision. In the splash zone, time averaging these measurements suggested the fluctuations were statistical. The temperature fluctuations in the freeboard did not scale as statistical noise suggesting some unsteady flows or other instabilities at these reactor conditions.

### EXAMPLE 2

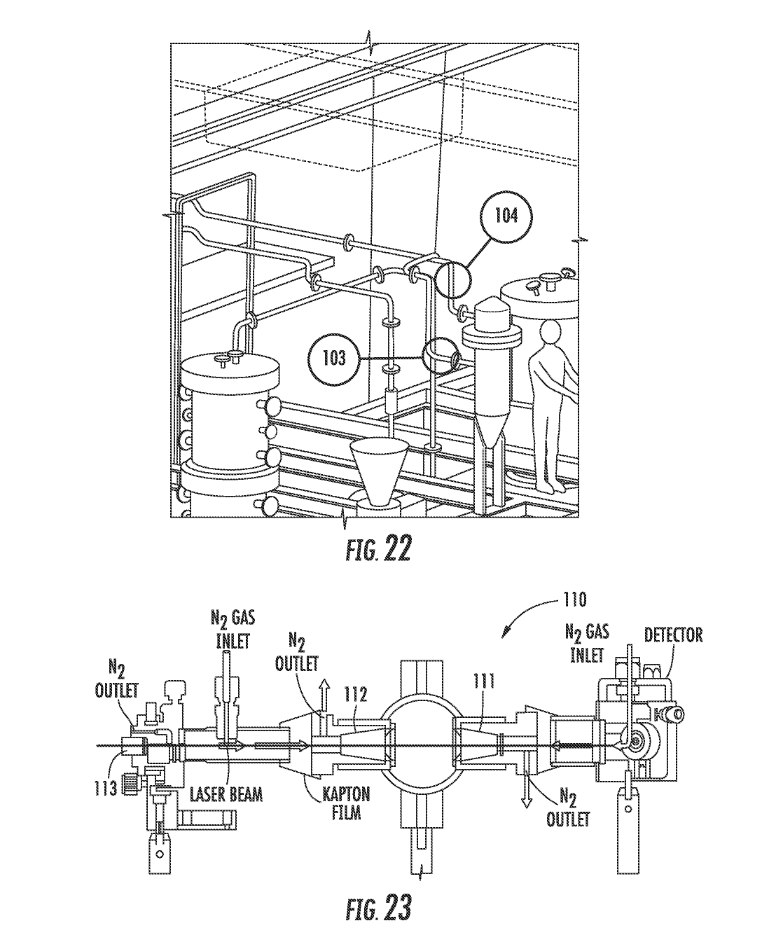

Referring to FIGS. 21 and 22, a reactor 100 of an entrained-flow, slagging coal gasifier and syn-gas processing are illustrated. The reference numerals in the figures illustrate the locations where optical access ports were installed to investigate the feasibility of laser absorption measurements. For example, location 101 is the reactor core where the pulverized coal is oxidized to release syn-gas; location 102 is at the exit of the reactor core, where the area of the flow-path is increased and cooling water is injected to quench the gasification reactions; location 103 is in the syn-gas product line just before the particulate is filtered; and location 104 is just after the particulate filter.

Measurements were performed at all four locations. The gas temperature at locations 101 and 102 ranges from 800-2000 K and the temperature at locations 103 and 104 ranges from 300-400 K. For each of these temperature ranges, a pair of water vapor absorption lines was selected to provide a sensitive temperature measurement from the ratio of the absorption. A two-line absorption sensor based on 1f-normalized wavelength-modulation spectroscopy with 2f detection where f is the modulation frequency was used. This strategy provides sensitive measurements in nearly opaque gas streams with large non-absorption losses in the optical transmission by particulate scattering and window fouling.

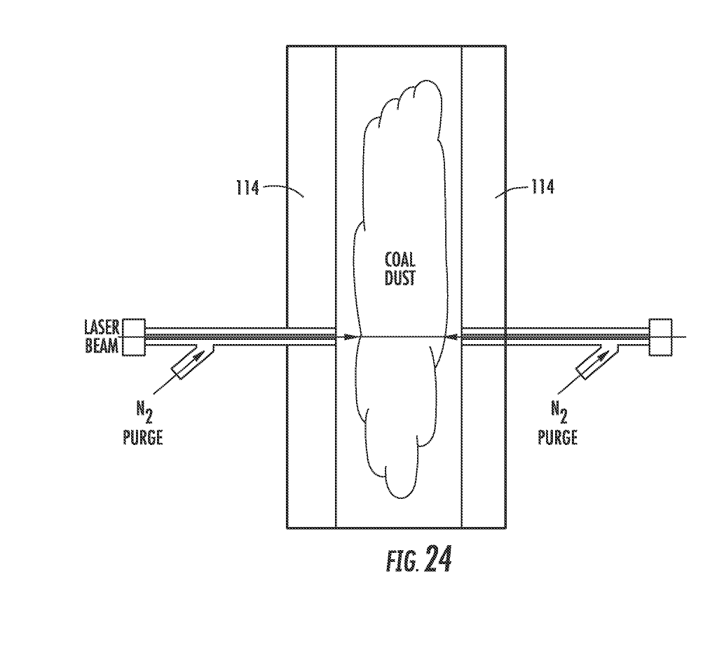

An optical access, like that shown in FIG. 23 at reference numeral 110, was used for measurements of laser absorption at locations 101-104. Note sapphire windows 111 and 112 are tapered to provide a safety margin to enable the reactor 100 to operate at pressures as high as 40 atm.

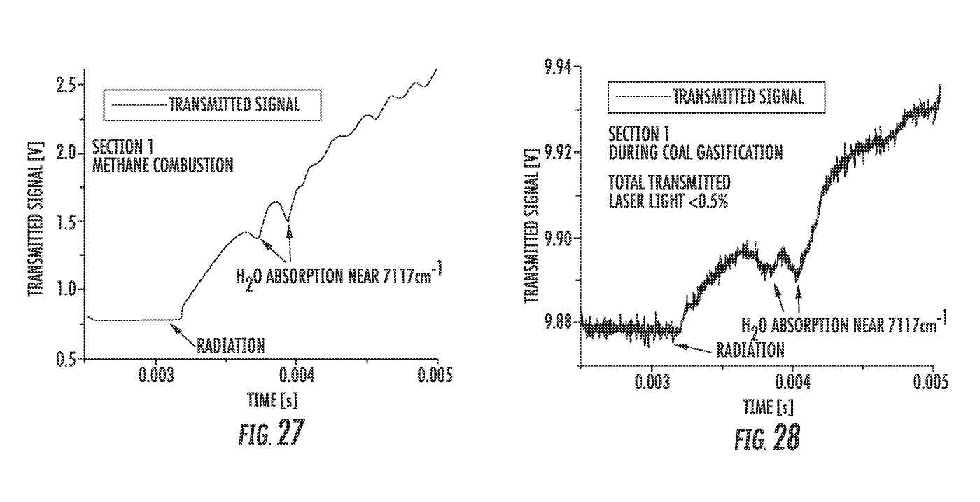

Due to the intensity of optical emission, optical filters may be used to suppress the optical emission background signal. FIG. 27 shows a single-sweep direct-absorption measurement for a methane burner during pre-heating of the reactor core prior to gasification without using an optical filter, and FIG. 28 shows a similar measurement during coal gasification. The interference signal from the radiation background is significant for both the methane and the coal-gasifier burners.

The laser beam path outside the reactor, as shown in FIG. 23, is purged with nitrogen gas (or dry air) to avoid any interference absorption by ambient water vapor. The laser light is delivered to a collimator 113 by an optical fiber. The temperature at locations 103 and 104 was near room temperature and the syn-gas is super-saturated in water vapor. Thus, the sensor section is heated to prevent condensation on the windows. Air curtains may also be used to prevent condensation. Temperature and water vapor concentration measurements were successfully performed at both locations 103 and 104 over multiple days of operation.

As illustrated in FIG. 24, an air curtain 114 was used for locations 101 and 102. The simple nitrogen purge at location 102 worked quite well and successful measurements were conducted during a full-day coal gasification experiment.

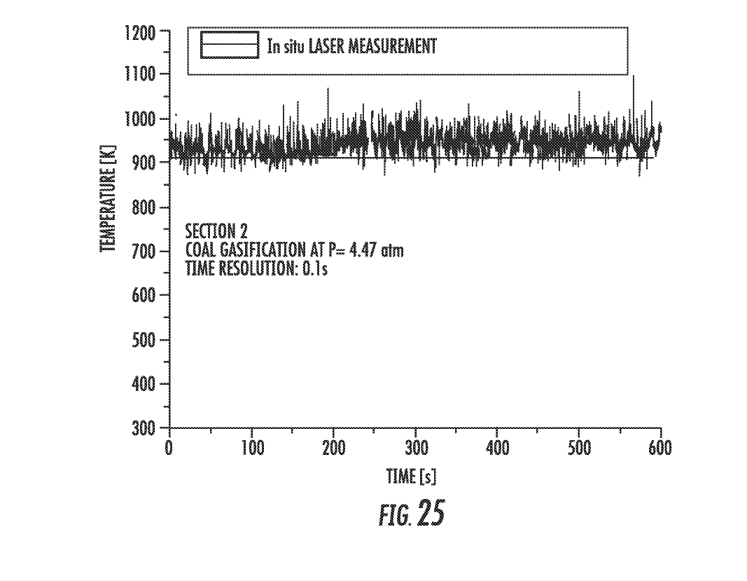

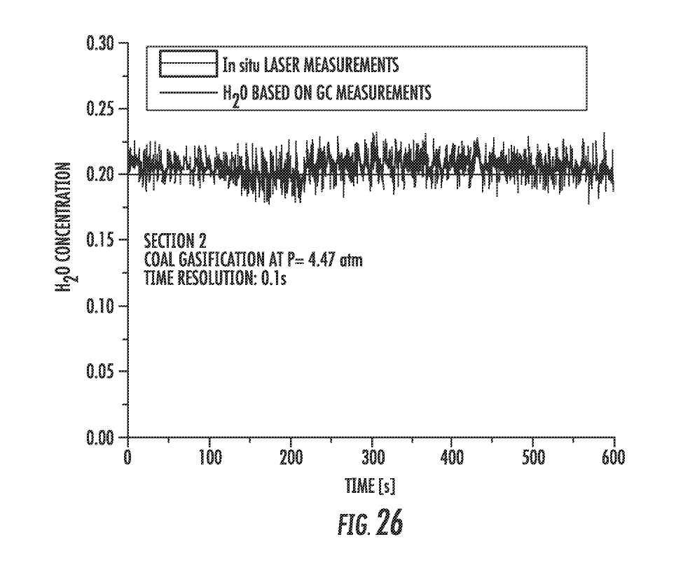

Examples of the measurements at location 102 are shown for temperature in FIG. 25 and water vapor concentration in FIG. 26. Note the time resolution is 0.1 seconds, which provides ample opportunity for signal averaging and/or the monitoring of flow fluctuations and instabilities. The measurement of water vapor concentration was in excellent agreement with gas chromatograph measurements of samples extracted downstream. However, the laser sensor measurement revealed changes in the gasifier conditions on the time scale of 10 seconds, while the GC data requires 600 seconds for a measurement.

FIG. 28 shows that the direct absorption water vapor absorption signal is prominent even when more than 99% of the incident light is attenuated by scattering from the coal particulate and from the slag forming on the windows. Thus, optical absorption measurements in the reactor core are feasible.

The foregoing has described a non-intrusive method for sensing gas temperature and species concentration in gaseous environments. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We Claim:

1. A method for sensing gas temperature and species concentration in gaseous environments, comprising the steps of:
(a) providing a tunable diode laser (TDL) sensor;
(b) using the TDL sensor to determine a ratio of absorbance for different absorption transitions; and
(c) determining a gas temperature from the ratio of absorbance.

2. The method according to claim 1, further including the step of determining a species concentration of the gas in the gaseous environment using the determined gas temperature.

3. The method according to claim 1, wherein the gaseous environment is a high temperature-high pressure environment.

4. The method according to claim 1, wherein the TDL sensor determines absorption transitions of water vapor in the near-infrared.

5. The method according to claim 1, wherein the TDL sensor determines a ratio of absorbance for two different absorption transitions of the same species.

6. A method for sensing gas temperature and species concentration in gaseous environments, comprising the steps of:
(a) providing a tunable diode laser (TDL) sensor having:
(i) a plurality of robust telecommunications diode lasers; and
(ii) a detector;
(b) positioning the TDL sensor in alignment with an optical port of a vessel;
(c) using the lasers to transmit light through the optical port;
(d) using the detector to receive the transmitted light and transmit a signal to a data collection device;
(e) determining a ratio of absorbance for different absorption transitions; and
(f) determining a gas temperature from the ratio of absorbance.

7. The method according to claim 6, wherein the TDL sensor is a wavelength-multiplexed TDL sensor.

8. The method according to claim 6, wherein wavelength-scanned direct absorption (DA) is used to determine a ratio of absorbance.

9. The method according to claim 6, wherein wavelength-scanned, wavelength-modulation spectroscopy (WMS) is used to determine a ratio of absorbance.

10. A method for sensing gas temperature and species concentration in high pressure gaseous environments, comprising the steps of:
(a) providing a plurality of tunable diode laser (TDL) sensors, each of the TDL sensors having:
(i) a plurality of robust telecommunications diode lasers; and
(ii) a detector;
(b) positioning the plurality of TDL sensors in optical alignment with respective optical ports of a pressure vessel such that the diode lasers and detector of each TDL sensor are in optical alignment with each other;
(c) using the TDL sensors to transmit and receive light through each of the respective optical ports;
(d) transmitting a signal representative of a ratio of absorbance for absorption transitions;
(e) determining the ratio of absorbance for absorption transitions; and
(f) determining a gas temperature from the ratio of absorbance.

11. The method according to claim 10, wherein at least one of the plurality of TDL sensors is positioned at an optical port located near a top of a splash zone in the pressure vessel.

12. The method according to claim 10, wherein at least one of the plurality of TDL sensors is located in a freeboard region of the pressure vessel.

13. The method according to claim 10, wherein at least one of the plurality of robust telecommunications diode lasers operates near 1310 nm and is free of H₂O absorption to determine losses by particulate scattering for a direct absorption measurement.

14. The method according to claim 10, further including the step of determining a species concentration of the gas in the gaseous environment using the determined gas temperature.
